(19) United States
(12) Patent Application Publication
(10) Pub. No.: US 2020/0245594 A1
(43) Pub. Date: Aug. 6, 2020

(54) PET WASTE BAG RETAINER APPARATUS

(71) Applicant: Houndswag LLC, Cape Elizabeth, ME (US)

(72) Inventor: Elizabeth Herriman, Cape Elizabeth, ME (US)

(21) Appl. No.: 16/546,537

(22) Filed: Aug. 21, 2019

Related U.S. Application Data
(63) Continuation-in-part of application No. 29/679,384, filed on Feb. 5, 2019, now Pat. No. D887143.

(51) Int. Cl. A01K 27/00; F16M 13/02

(52) U.S. Cl. CPC A01K 27/008; F16M 13/02

(57) ABSTRACT

A pet waste bag retainer for use with pet waste bags, which includes a receiving section and a retaining section, with an optional fastening receptacle. The receiving section is oriented with an opening for the insertion of a portion of a pet waste bag. The retaining section is oriented to removably retain therein one or more pet waste bags.

### BACKGROUND OF THE INVENTION

### 1. Field of the Invention

The present invention relates to an apparatus that can be used to facilitate the carrying of one or more bags or other items without having to physically hold the bag or item. More specifically, the apparatus is used for carrying pet waste bags.

### 2. Description of the Prior Art

Typically, pet owners carry small pet waste bags, which are used for cleaning up pet excrement during a walk outside. During the walk, the pet may produce excrement in a populated area, public walkway or space, or in any other undesirable location. Often times, the pet will defecate in an area where there are no public waste bins so the user is forced to carry the waste bag by hand. Some users may find this burdensome as it can limit the use of free hands while the user has the pet on a leash in one hand, and the waste bag in the other. Additionally, carrying the waste bag in hand may be unsanitary because of the waste product inside the bag and potential of the bag breaking during the walk. Furthermore, individuals may have several pets which may make carrying multiple bags in combination with multiple leashes difficult. What is needed is an apparatus to enable the convenient carrying of a pet waste bag.

### SUMMARY OF THE INVENTION

It is an object of the present invention to provide an apparatus wherein the user can insert and retain a pet waste bag without having to carry the bag by hand. The present apparatus is configured with a bag receiving section and a bag retaining section. The receiving section is arranged to have an opening wherein the user can insert a portion of the pet waste bag. The retaining section is arranged to be sufficiently narrow such that the bag is trapped and removably retained within the apparatus. The apparatus may attach to a pet leash. The user is then able to pick up the pet excrement in the pet waste bag, place a portion of the bag in the receiving section and slide the bag into the retaining section. Once in the retaining section, the bag remains removably trapped therein between a first leg and a second leg of the retaining section until the user slides the bag back along the retaining section into the receiving section wherein the bag may be removed from the apparatus.

It is another object of the present invention to provide an apparatus wherein the user can retain a pet waste bag for a length of time until a trash receptacle is accessible. The retaining section is configured to form a narrow opening between the first leg and the second leg to grasp the bag without requiring additional handling of the bag while in the retaining section. Once the bag is in the retaining section of the apparatus, the user can complete the walk without having to physically touch or carry the bag by hand in an unsightly or unsanitary way. While in the apparatus, the waste bag is less at risk of breaking while in the user's hand, exposing them to direct contact with fecal matter.

It is a further object of the present invention to allow the user to carry multiple pet waste bags at once. The retaining section is configured with the first leg and second leg having sufficient length that can accommodate and retain multiple pet waste bags stacked on one another. Some pets may defecate more than once on an extended walk, or a user may take multiple pets on a walk, requiring the use of multiple waste bags. The apparatus is oriented so that the retaining section may retain several bags at once, resolving the issue of having to carry multiple bags when the user is traveling extended distances and/or with multiple pets.

### BRIEF DESCRIPTION OF THE DRAWINGS

FIG. 1 is a perspective front view of the apparatus of the present invention depicting the retaining section, the receiving section, and an optional fastening receptacle.

FIG. 2 is a front view of the apparatus.

FIG. 3 is a back view of the apparatus.

FIG. 4 is a side view of the apparatus depicting the first leg.

FIG. 5 is a side view of the apparatus depicting the second leg.

FIG. 6 is a top view of the apparatus with the optional fastening receptacle.

FIG. 7 is a bottom view of the apparatus depicting the retaining section and a partial view of the receiving section.

### DETAILED DESCRIPTION OF AN EMBODIMENT OF THE PRESENT INVENTION

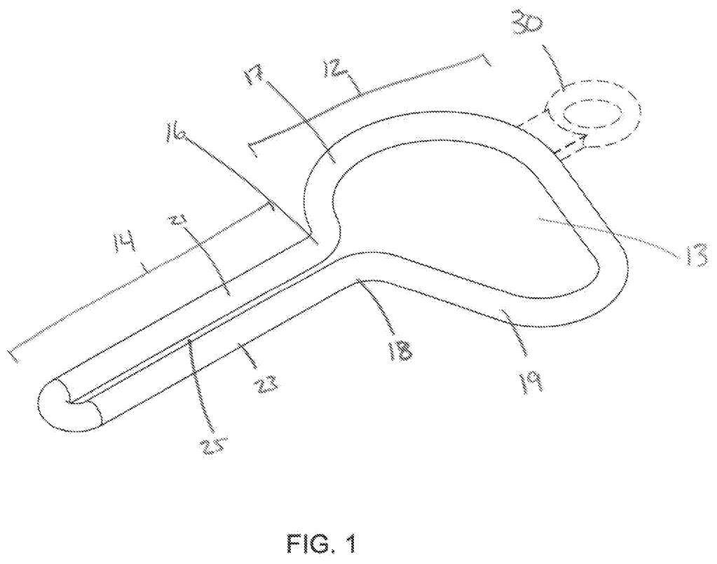

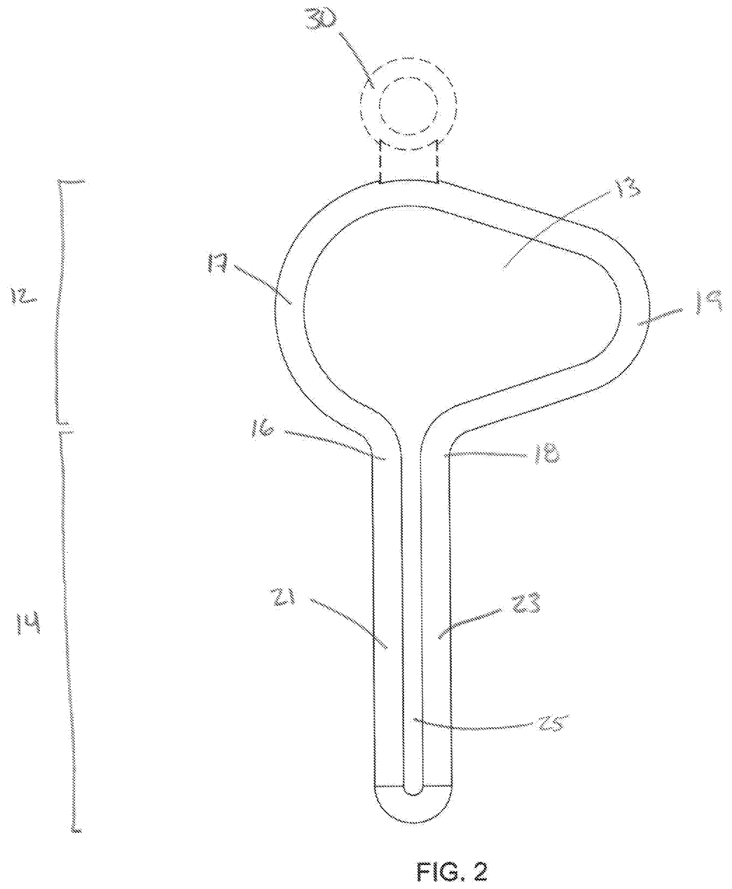

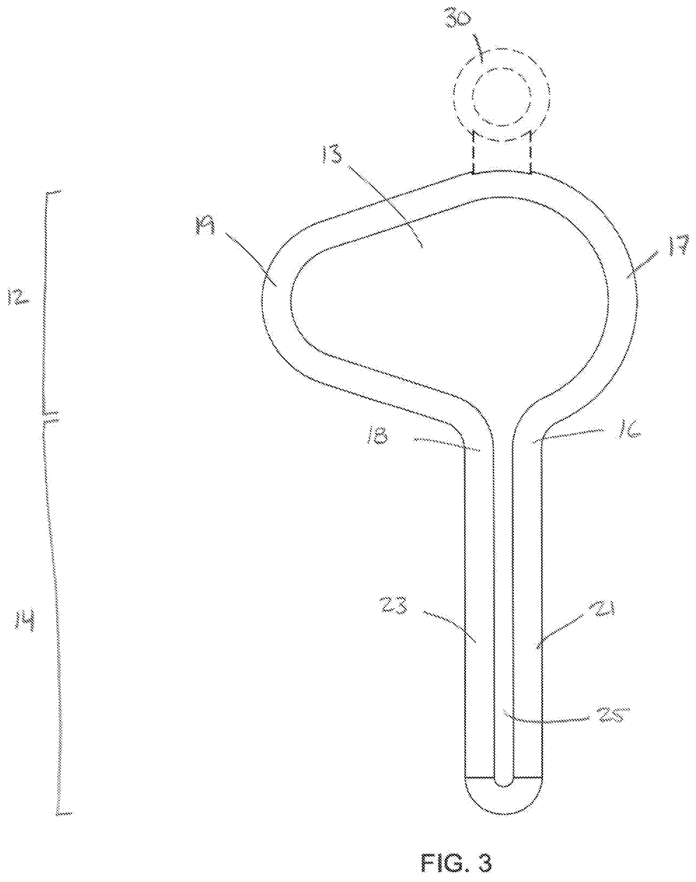

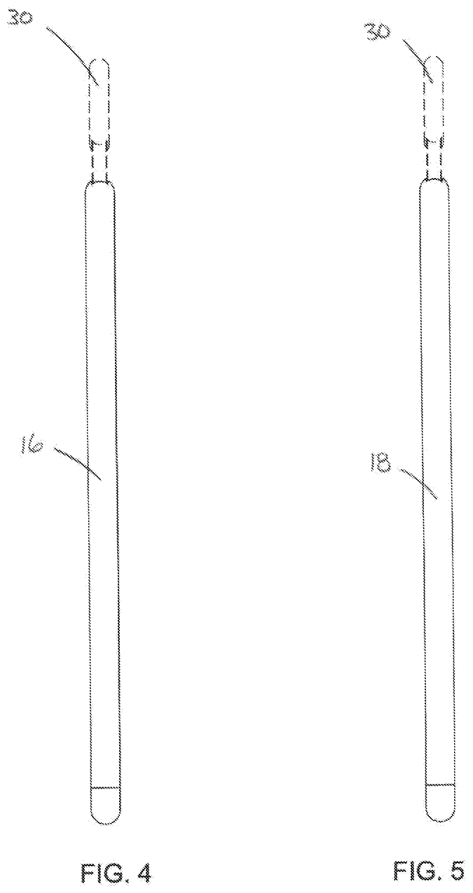

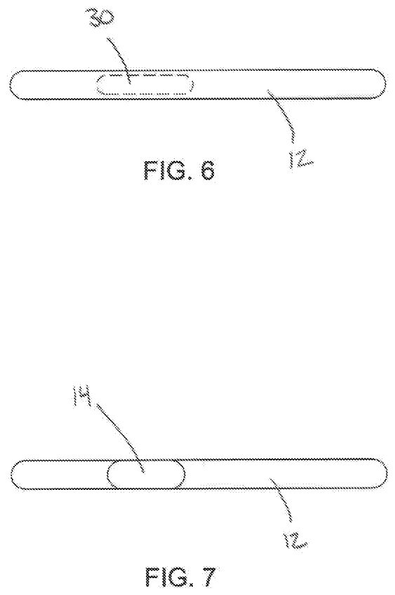

A pet waste bag retainer apparatus 10 of the present invention is shown in FIGS. 1-7. The retainer 10 is a unitary loop having a receiving section 12 and a retaining section 14. The retaining section 14 has a first leg 16 and a second leg 18. The receiving section 12 includes a loop portion 15 and an opening 13 wherein a portion of the pet waste bag may be inserted. The first leg 16 and second leg 18 of the retaining section 14 are oriented in a parallel fashion wherein the inserted pet waste bag is retained. The first leg 16 and second leg 18 are oriented in a sufficiently narrow fashion to prevent the bag from slipping out of the retaining section 14.

The embodiment of the retainer 10 shown in FIGS. 1-7 illustrates the receiving section 12 with an oblong configuration wherein the opening 13 is sufficiently size to easily pass at least a portion of the pet waste bag therethrough. The receiving section 12 may also be configured with another shape including, but not limited to, diamond, square, rectangle, oval, round or some polygon form so long as the opening 13 is sufficient to receive at least a portion of the pet waste bag.

The embodiment of the retainer 10 shown in FIGS. 1-7 includes the first leg 16 and the second leg 18 of the retaining section 14 aligned in a substantially parallel configuration arranged to enable retention of the waste bag therebetween. The retaining section 14 may also be oriented in a narrowing or tapered arrangement wherein the first leg 16 and the second leg 18 are progressively closer to each other moving away from the receiving section 12. A narrowing orientation between the first leg 16 and the second leg 18 may provide additional pressure to retain the pet waste bag as the user slides the inserted bag into the retaining section 14 away from the receiving section.

The retainer 10 is made of a material and/or thickness that has sufficient flexibility when formed into the shape of the retaining section 14 so that there is enough give to provide a frictional retention of the bag in space 25 between the first leg 16 and second leg 18 of the retaining section 14. In addition, the distance of the space 25 between the first leg 16 and second leg 18 is configured so that a knotted or unknotted waste bag fits snugly therebetween so that it may only be removed by intended force to return it to the receiving section 14. A material suitable for making the retainer 10 is a non-metallic material such as a polymeric material such as a plastic material. The material used to make the retainer 10 may also be metallic that is fabricated so that there is some relative give between the first leg 16 and the second leg 18 enough to enable insertion of the waste bag in space 25 and retention of the bag in the space 25.

The retainer 10 includes an optional fastening receptacle 30. The fastening receptacle 30 may be formed as a loop or hook such that it is able to be attached to a pet leash. The fastening receptacle 30 provides a method for the user to attach the device to a leash such that the user is not required to handle the retainer 10 while on a walk.

Although the retainer has been described as a unitary structure, it may be formed of multiple pieces. For example, the receiving section 12 and the retaining section 14 may be two distinct pieces permanently or removably joined together. The multiple pieces may be formed of the same or different materials.

Although an embodiment of the present invention has been described herein, the above description is merely illustrative. Further modification of the invention herein disclosed will occur to those skilled in the respective arts and all such modifications are deemed to be within the scope of the invention as defined by the appended claims.

What is claimed is:

1. A pet waste bag retainer for use with a waste bag comprising:
a unitary loop having a receiving section including a loop portion and a retaining section including a first leg and a second leg wherein the first leg and second leg are oriented in a parallel or narrowing fashion in the retaining section, wherein a space within the loop portion of the receiving section is sufficiently wide enough to receive a portion the waste bag, and a space between the first leg and the second leg in the retaining section is sufficiently narrow enough to retain the waste bag by creating inward pressure to grasp the bag when it is slid in between the first leg and the second leg in the retaining section.

2. The retainer of claim 1 wherein the joined loop is made of a non-metallic material.

3. The retainer of claim 1 wherein the receiving section of the apparatus is oriented with a circular opening within the loop portion.

4. The retainer of claim 1 wherein the first leg and the second leg of the retaining section are substantially parallel to one another.

5. The retainer of claim 1 wherein the first leg and the second leg of the retaining section are substantially oriented in a tapered fashion with respect to one another such that the first leg and second leg become increasingly closer to one another moving further from the receiving section.

6. The retainer of claim 1 wherein the device has a fastening receptacle comprising a continuous, joined loop having a middle opening wherein the fastening ring may be attached to another device such as a leash.

7. The retainer of claim 6 wherein the fastening receptacle is a closed loop for receiving a fastening component.

8. The retainer of claim 6 wherein the fastening receptacle is a hook or open-ended apparatus able to latch on to section of a pet leash or other pet control device.
